(19) United States
(12) Patent Application Publication
(10) Pub. No.: US 2010/0141899 A1
(43) Pub. Date: Jun. 10, 2010

(54) Projection apparatus

(75) Inventors: Wen-Chang Chien, Hsinchu (TW); Jui-Chi Chen, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsin-Chu (TW)

(21) Appl. No.: 12/591,807

(22) Filed: Dec. 2, 2009

(30) Foreign Application Priority Data
Dec. 8, 2008 (TW) 097147595

(51) Int. Cl. G03B 21/14

(52) U.S. Cl. 353/43

(57) ABSTRACT

A projection apparatus includes a housing, a connector, a control module, and an optical module. The housing provides a battery chamber. An interface aperture is inside the battery chamber. The connector is disposed in the housing and provides a signal transmitting interface located in the interface aperture inside the battery chamber. The control module includes an error-detecting circuit and a microprocessor. The error-detecting circuit is electrically connected to the signal transmitting interface and the microprocessor, and the microprocessor is electrically connected to the signal transmitting interface through the error-detecting circuit. The optical module is disposed in the housing and electrically connected to the control module.

### BACKGROUND OF THE INVENTION

(1) Field of the Invention

The invention relates to a projection apparatus, and more particularly relates to a projection apparatus with error-detecting function.

(2) Description of the Related Art

In recent years, with rapid development of the projector, micro projection system becomes a new trend in the projector market.

FIG. 1 is a schematic diagram of a handheld micro projection system 100. A housing 120 of the handheld micro projection system 100 has an error-detecting aperture 122 exposed directly on the outer surface of the housing 120 for detecting system errors.

Generally, the error-detecting aperture 122 is provided for maintenance men rather than common users. As for current products of the handheld micro projection system 100, no special design is for covering or decorating the error-detecting aperture 122, and thus affects appearance of the products.

In other conventional micro projection apparatuses, an error-detecting interface is disposed on the motherboard of the host computer rather than reserving the error-detecting aperture 122 on the housing. Thus when the micro projection system has any error to be analyzed or the firmware needs updating, the whole housing has to be disassembled.

In summary, if the error-detecting aperture is disposed on the housing of the micro projection system, the error-detecting aperture is useless for users and also affects appearance of the product. If the error-detecting aperture is not disposed on the housing, the product needs to be disassembled, and error detecting becomes difficult.

### SUMMARY OF THE INVENTION

One object of the invention to provide a projection apparatus with an error-detecting aperture located at a position good for designing products appearance.

To achieve at least one of the above-mentioned advantages, an embodiment of the invention provides a projection apparatus including a housing, a connector, a control module, and an optical module. The housing provides a battery chamber. At least one interface aperture is disposed inside the battery chamber. The connector is disposed inside the housing, and includes a signal transmitting interface, the signal transmitting interface is disposed in the interface aperture of the battery chamber. The control module includes an error-detecting circuit and a microprocessor. The error-detecting circuit is electrically connected to the signal transmitting interface and the microprocessor. The microprocessor is electrically connected to the signal transmitting interface through the error-detecting circuit. The optical module is disposed in the housing and electrically connected to the control module.

The housing includes a power plug electrically connected to the control module for electrically connecting a power source outside the housing. The connector includes a power transmitting interface and a data transmitting interface, the microprocessor is electrically connected to a firmware, the power transmitting interface is electrically connected to the power plug, and the data transmitting interface is electrically connected to the firmware through the microprocessor.

The signal transmitting interface, the power transmitting interface, and the data transmitting interface of the connector are all adapted to electrically connect to an error-detecting device outside the housing. The error-detecting device is capable of providing an error-detecting signal, and the error-detecting signal is capable of being transmitted to the microprocessor through the signal transmitting interface and the error-detecting circuit. The power source is capable of providing power to the error-detecting device through the power transmitting interface, and the error-detecting device is capable of loading a software to the firmware through the data transmitting interface.

In an embodiment, the signal transmitting interface, the power transmitting interface, and the data transmitting interface are disposed in three different interface apertures respectively.

In an embodiment, the signal transmitting interface, the power transmitting interface, and the data transmitting interface of the connector are all disposed in the same interface aperture.

To sum up, the embodiment or embodiments of the invention may have at least one of the following advantages, the error-detecting interface apertures for maintenance are disposed inside the battery chamber for decreasing the number of the interface apertures on outer surface of the product, and is good for appearance of the product, and also the maintenance men need to remove the battery during maintenance, and use external power source for stable power during error-detecting.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram of a conventional micro projection apparatus.

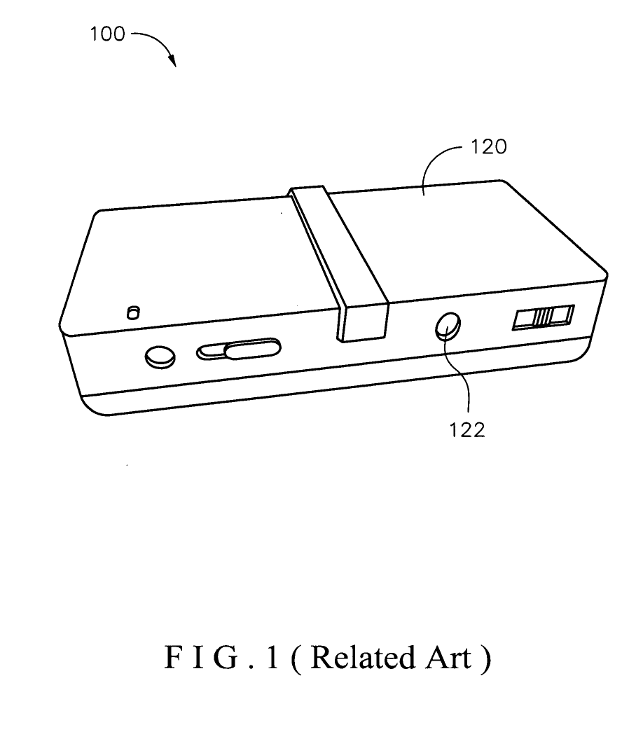

FIG. 2 is a schematic diagram of a projection apparatus in accordance with an embodiment of the invention.

FIG. 2B is a block diagram of a projection apparatus in accordance with an embodiment of the invention.

FIG. 3 is a profile view of an error-detecting interface aperture of the projection apparatus in accordance with an embodiment of the invention.

FIG. 4 is a profile view of an error-detecting interface aperture of the projection apparatus in accordance with an embodiment of the invention.

### DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

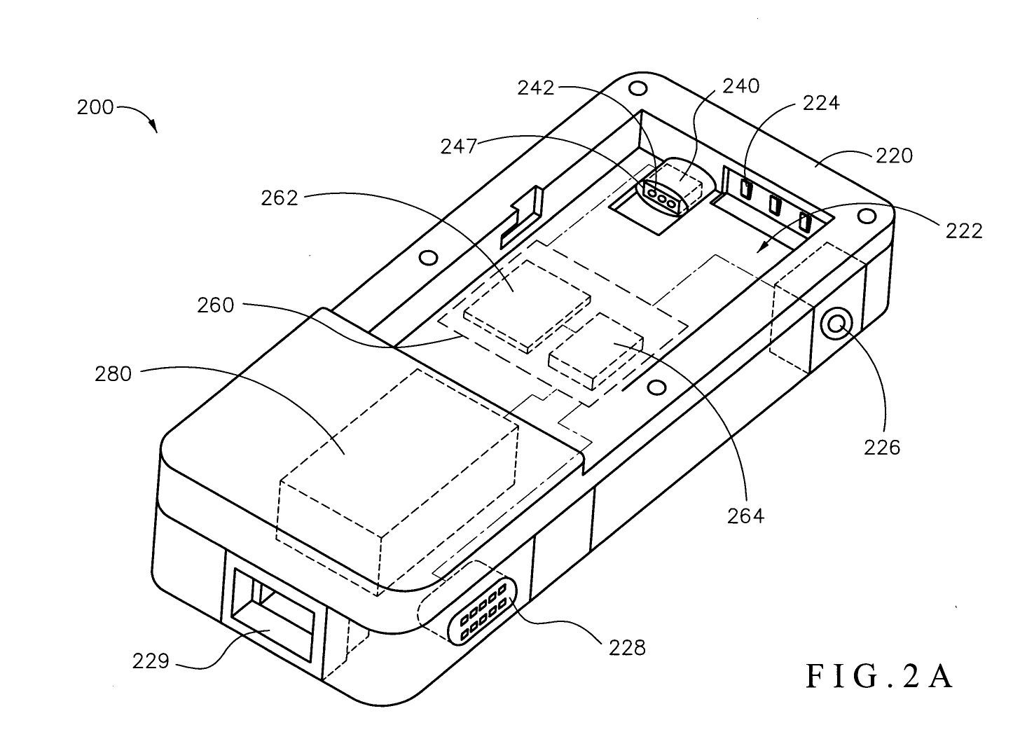

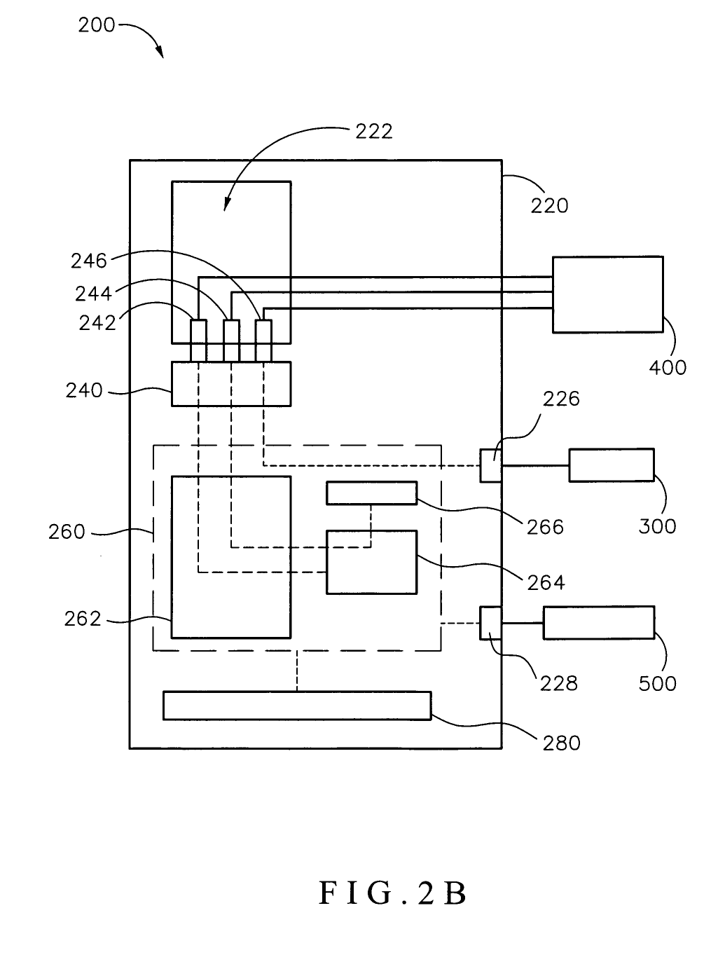

Please refer to FIG. 2A, the projection apparatus 200 is a micro projection apparatus, including a housing 220, a connector 240, a control module 260, and an optical module 280. The housing 220 provides a battery chamber 222. An interface aperture 247 is disposed inside the battery chamber 222. The connector 240 is disposed in the housing 220 and provides an signal transmitting interface 242 located in the interface aperture 247 inside the battery chamber 222. The control module 260 includes an error-detecting circuit 262 and a microprocessor 264. The error-detecting circuit 262 is electrically connected to the signal transmitting interface 242 of the connector 240 and the microprocessor 264, and the microprocessor 264 is electrically connected to the signal transmitting interface 242 through the error-detecting circuit 262. The optical module 280 is disposed in the housing 220 and electrically connected to the control module 260.

The battery chamber 222 of the housing 220 has an electrode contacting portion 224 for being electrically connected to the electrode of a battery (not shown). In addition, the housing 220 has a power plug 226 and an image transmitting aperture 228. The power plug 226 is electrically connected to the control module 260 and capable of accepting the current supplied by an power source (not shown) outside the housing 220 for providing the power for the control module 260. The image transmitting aperture 228 is capable of receiving image data inputted from outside.

The optical module 280 includes a light source, a lens, an integration rod, a light combining module, an image generating component like a liquid crystal panel or a digital micromirror device (DMD), and a projection lens 229. The microprocessor 264 of the control module 260 converts the inputted image data into signal for driving the optical module 280 to generate an image corresponding to the image data and project the image out through the projection lens 229.

Please refer to FIG. 2B, the connector 240 includes a power transmitting interface 246 and a data transmitting interface 244 besides the signal transmitting interface 242. In the embodiment, the signal transmitting interface 242, the power transmitting interface 246, and the data transmitting interface 244 of the connector 240 are all electrically connected to an error-detecting device 400 located outside the housing 220. In an embodiment, the signal transmitting interface 242, the power transmitting interface 246, and the data transmitting interface 244 are three wires actually.

An error-detecting device 400 may be a computer installed with an error-detecting software or stored a control software of the projection apparatus 200. As shown in FIG. 2B, the error-detecting device 400 is capable of providing an error-detecting signal transmitted through the signal transmitting interface 242 of the connector 240 to the error-detecting circuit 262 and then to the microprocessor 264 to execute error-detecting.

The power plug 226 is connected to an external power source 300 located outside the housing 220. Power from the power source 300 is transmitted to the control module 260 and the error-detecting device 400. The power transmitting interface 246 is electrically connected to the power plug 226, so the power is directly transmitted to the error-detecting device 400 through the power transmitting interface 246, or the power is transmitted to the error-detecting device 400 through the control module 260 firstly and then through the power transmitting interface 246. The image transmitting aperture 228 is provided for receiving an image data source 500 from a device such as a notebook computer, a video compact disc(VCD) player or a digital versatile disc(DVD) player.

A firmware 266 is electrically connected the microprocessor 264 or built in the microprocessor 264. The data transmitting interface 244 is electrically connected to the firmware 266 through the microprocessor 264. If the error-detecting device 400 is installed with the control software for the projection apparatus 200, the error-detecting device 400 may load the control software to the firmware 266 through the data transmitting interface 244.

In the embodiment, the interface aperture 247 for error-detecting is disposed inside the battery chamber 222 of the projection apparatus 200. When a battery is placed in the battery chamber 222, the battery covers the interface aperture 247. When the projection apparatus needs maintenance or repairs, the maintenance men may remove the battery of the projection apparatus 200 at first for exposing the interface aperture 247, and then connects the error-detecting device 400 to the connector 240 and also connects the power source 300 to the power plug 226. In this way, the power source 300 provides power stably during error-detecting or downloading the control software to avoid any interruption due to insufficient power.

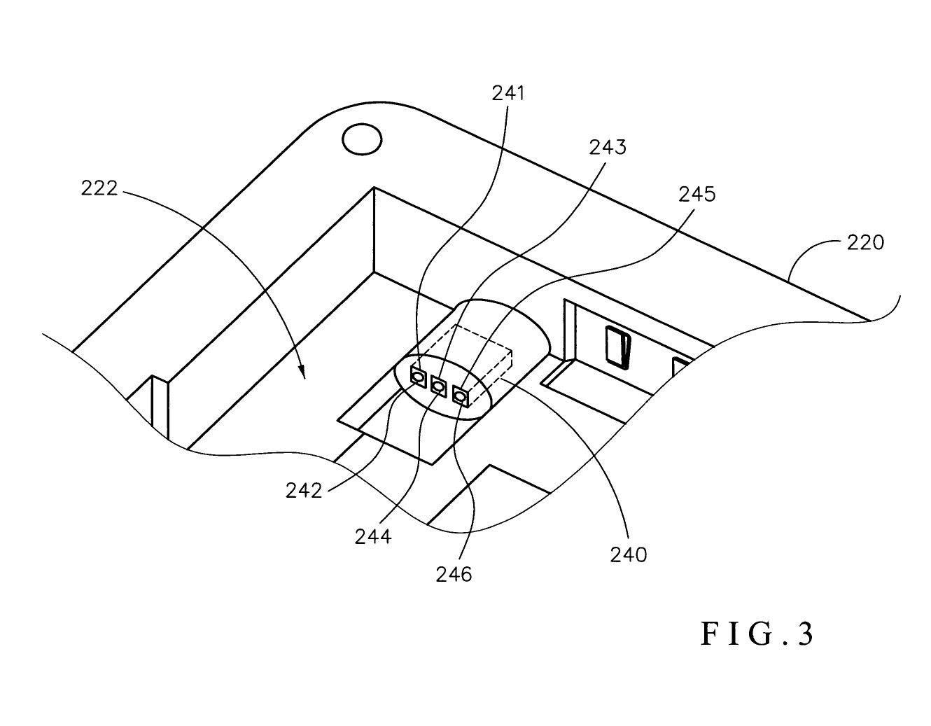

Please refer to FIG. 3. In the embodiment, a number of the interface aperture is three. The signal transmitting interface 242, the data transmitting interface 244, and the power transmitting interface 246 of the connector 240 are disposed in the three interface apertures 241, 243, 245 respectively.

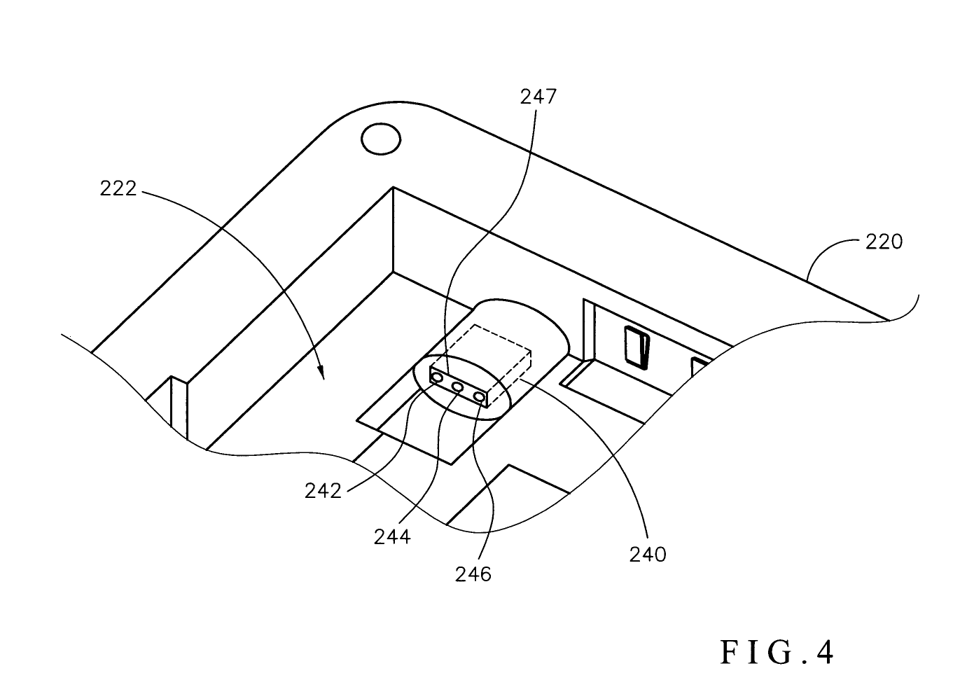

Please refer to FIG. 4. In the embodiment, the signal transmitting interface 242, the data transmitting interface 244, and the power transmitting interface 246 of the connector 240 are disposed in the same interface aperture 247.

According to the above embodiments, the error-detecting interface aperture is disposed inside the battery chamber 222 of the projection apparatus 200, so that the interface aperture does not affect appearance of the product. On other hand, if the user need reinstall the control software, the user takes off the battery and uses the external power source 300 outside the housing 200 to avoid interrupting downloading software and destroying the projection apparatus due to insufficient power of the battery.

To sum up, the embodiment or the embodiments of the invention mat have at least one of the following advantages, the error-detecting interface apertures for maintenance are disposed inside the battery chamber, so as to decrease the number of the interface apertures on outer surface of the product and be good for appearance of the product, besides, the maintenance men need to remove the battery during maintenance, and use external power source for stable power during error-detecting.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
a housing, providing a battery chamber, at least one interface aperture disposed inside the battery chamber;
a connector, disposed inside the housing, comprising a signal transmitting interface, the signal transmitting interface disposed in the interface aperture of the battery chamber;
a control module, comprising an error-detecting circuit and a microprocessor, the error-detecting circuit electrically connected to the signal transmitting interface and the microprocessor, the microprocessor electrically connected to the signal transmitting interface through the error-detecting circuit; and
an optical module, disposed in the housing and electrically connected to the control module.

2. The projection apparatus according to claim 1, wherein the housing comprises a power plug electrically connected to the control module for electrically connecting a power source outside the housing.

3. The projection apparatus according to claim 2, wherein the connector comprises a power transmitting interface and a data transmitting interface, the microprocessor electrically connected to a firmware, the power transmitting interface electrically connected to the power plug, and the data transmitting interface electrically connected to the firmware through the microprocessor.

4. The projection apparatus according to claim 3, wherein the signal transmitting interface, the power transmitting interface, and the data transmitting interface of the connector are all adapted to electrically connect to an error-detecting device outside the housing, the error-detecting device capable of providing an error-detecting signal, the error-detecting signal capable of being transmitted to the microprocessor through the signal transmitting interface and the error-detecting circuit, the power source capable of providing power to the error-detecting device through the power transmitting interface, and the error-detecting device capable of loading a software to the firmware through the data transmitting interface.

5. The projection apparatus according to claim 3, wherein a number of the interface aperture is three, and the signal transmitting interface, the power transmitting interface, and the data transmitting interface are disposed in the three interface apertures respectively.

6. The projection apparatus according to claim 3, wherein the signal transmitting interface, the power transmitting interface, and the data transmitting interface of the connector are all disposed in the same interface aperture.
